(19) United States
(12) Patent Application Publication
(10) Pub. No.: US 2011/0111988 A1
(43) Pub. Date: May 12, 2011

(54) Electrically Conductive Oil Base Drilling Fluids Containing Carbon Nanotubes

(75) Inventors: Luminita Liliana Ionescu Vasii, Calgary (CA); Arkadz Fatseyeu, Calgary (CA)

(73) Assignee: Newpark Canada, Inc.

(21) Appl. No.: 12/942,866

(22) Filed: Nov. 9, 2010

Related U.S. Application Data
(60) Provisional application No. 61/259,330, filed on Nov. 9, 2009.

(51) Int. Cl. C09K 8/34; B82Y 99/00

(52) U.S. Cl. 507/103; 507/140; 977/742

(57) ABSTRACT

Electrically conductive oil base drilling fuids with carbon nanotubes have either an organic base (oil) or a base that is an emulsion of water in oil (invert emulsion) and contains carbon nanotubes dispersed in oil. These drilling fluids may be prepared by either (1) the addition of electrically conductive dispersions of carbon nanotubes in oil to conventional oil base drilling fluids (unweighted or weighted) or (2) the sonication of the mixture of oil pre-wetted carbon nanotubes with unweighted conventional oil base drilling fluids. The electrically conductive dispersions of carbon nanotubes in oil may be prepared by sonication or by microfluidization. The oil may be a mineral oil, paraffin oil, synthetic oil, or diesel oil. The electrically conductive oil-based drilling fluids may further contain ionic, non-ionic or polymeric surfactants.

This application claims the benefit of U.S. patent application Ser. No. 61/259,330, filed on Nov. 9, 2009, herein incorporated by reference in its entirety.

### FIELD OF THE INVENTION

The invention relates to the preparation and use of electrically conductive oil base drilling fluids containing carbon nanotubes.

### BACKGROUND OF THE INVENTION

Well logging is a detailed documentation of a geologic formation penetrated by a borehole that is done when drilling boreholes for oil and gas, groundwater, minerals, environmental and geological studies. This detailed documentation (log) is based either on visual inspection of samples brought to the surface (geological log) or on measurements made by instruments lowered into the hole (electrical or geophysical log). When drilling for oil and gas high resolution electrical or acoustical imaging logs are used to visualize the formation, compute the formation dip, and analyze thinly-layered and fractured reservoirs. These images are also used for determining formation testing, sampling and perforating. For thinly laminated turbidite sands and other sequences, the use of imaging logs is often the only practical method of determining net sand and deposit thicknesses.

Due to their inherent high-resolution capability and the wide dynamic range of the formation properties that can be measured, the resistivity well logs are usually chosen to define geological features. The resistivity logs are based on the measurement of subsurface electrical resistivities, normal and lateral to the borehole. The conventional resistivity imaging devices are sending an alternating current radially out from one or more electrodes into the formation and receiving the current returns via the drilling fluid column. The presence of a current path through the drilling fluid and filter cake which may be present between the electrodes and the borehole wall is mandatory in logging with conventional resistivity devices. Several types of resistivity logs with various designs are presently commercially available. They can be either wireline tools or logging while drilling devices. If for the wireline micro-resistivity logs, the electrodes are placed on a series of pads which are pressed into contact with the borehole walls, for the logging while drilling devices the electrodes are integrated into the drill string (e.g. Resistivity-at-bit-while-drilling-devices). In each case the performance of the conventional resistivity devices is related to the use of a low-resistivity/high conductivity drilling fluid.

Water base drilling fluids (water-base muds or WBMs) are conductive unlike the oil base drilling fluids (oil-base muds or OBMs) that are non-conductive. OBMs are used in critical operations where costs and risks are high. When drilling with a conventional OBM is desired, the replacement of the oil mud with a conductive WBM for logging with resistivity tools is not desired because the risk of borehole instability increases. The electrical non-conductive nature of oil-base muds renders conventional resistivity-imaging devices ineffective, limiting the options to ultrasonic devices and dipmeter tools. These alternative methods can increase costs and may result in missing, insignificant or inoperative data. Consequently the design of electrically conductive oil base muds is highly desirable.

### SUMMARY OF THE INVENTION

Electrically conductive oil base drilling fluids containing carbon nanotubes (buckytubes) have been prepared by (1) the addition of electrically conductive dispersions of carbon nanotubes in the organic phase of the fluid (oil) to an unweighted or weighted conventional oil base drilling fluid or (2) the sonication of mixtures of oil pre-wetted carbon nanotubes (buckytubes) with unweighted conventional oil base drilling fluids. The density of these fluids being adjusted as needed. The electrically conductive oil base drilling fluids with carbon nanotubes have either an organic base (oil) or a base which is an emulsion of water in a continuous organic phase (oil) (an invert emulsion base). The drilling fluids with an invert emulsion base are also known as invert-emulsion drilling fluids (invert-emulsion muds). The content of water of the electrically conductive invert-muds described herein is at most 40% by volume. Further in the fluids described herein the carbon nanotubes are dispersed in the continuous organic phase of the fluid.

The concentration of the carbon nanotubes (buckytubes) in the electrically conductive oil base muds is typically between from about 0.01% to about 5.0% by weight to the oil, preferably not more than 3.0% by weight to the oil.

The organic base of the fluids is mineral oil, diesel oil, paraffin oil or synthetic oil.

The electrically conductive oil-base drilling muds may contain an ionic, non-ionic or polymeric surfactant, or their mixture, unlike the surfactants used to emulsify water in invert-emulsion muds. When present, the weight ratio of surfactant to carbon nanotubes is between from about 10 to 1 to about 1 to 1.

The electrically conductive dispersions of carbon nanotubes (buckytubes), in the organic phase of the fluids, which have been used to prepare the herein electrically conductive oil base muds, have been produced either by sonication or microfluidizer processors.

The electrically conductive oil base drilling fluids prepared as described herein have low electrical resistivity (high electrical conductivity) and may be used for well logging with conventional resistivity devices-imaging logging tools. The resistivity-imaging devices have high-resolution capability and allow the measurement of a wide dynamic range of the formation properties, being usually selected in defining geological features.

### BRIEF DESCRIPTION OF THE DRAWINGS

In order to more fully understand the drawings referred to in the detailed description of the present invention, a brief description of each drawing is presented, in which:

FIG. 1 illustrates the evolution of the electrical conductivity of four oils, used as bases in conventional oil base muds.

FIG. 2 illustrates the evolution of the electrical conductivity of four oils and of solutions of different surfactants in these oils.

FIG. 3 illustrates the morphology of a dispersion of carbon nanotubes in a hydrocarbon type solvent, the dispersion having been prepared by sonication.

FIG. 4 illustrates the evolution of the morphology of dispersions of carbon nanotubes prepared by microfluidization.

FIG. 5 illustrates the effect of surfactants used to disperse carbon nanotubes on the morphology of the dispersion as well as the influence of the processing parameters on the morphology of dispersions prepared by microfluidization.

FIG. 6 illustrates the effect of two different carbon nanotubes dispersed with two different surfactants as well as the effect of processing parameters on the morphology of dispersions prepared by microfluidization.

### DETAILED DESCRIPTION OF THE PREFERRED EMBODIMENTS

The oil base drilling fluids described herein are electrically conductive. The fluids contain carbon nanotubes and have either a continuous organic base (oil) or a continuous base which is an emulsion of water in oil (an invert-emulsion base) where the carbon nanotubes appear in the organic phase (oil) of the fluid base.

The oil is preferably a mineral oil, a paraffin oil, synthetic oil, or diesel oil.

The content of water in the electrically conductive invert-emulsion muds is not in excess of 40% by volume and more typically is more than 2% by volume.

The carbon nanotubes (also known as Buckytubes) used herein are members of the fullerene structural family (hollow structures composed entirely by carbon atoms). They are crystalline structures, cylindrically shaped and are composed of a variety of carbons in a sp² configuration. They can be single-walled carbon nanotubes (SWNTs), double walled carbon nanotubes (DWNTs) and multi-walled carbon nanotubes (MWNTs). MTNTs can, for example, include between 5 and 15 layers.

The carbon nanotubes are composed of aromatic rings that are arranged side-by-side with each other. Further, the carbon nanotubes may be viewed as graphene sheets rolled into cylinders with at least one end, typically capped with a hemisphere of the buckyball structure.

The carbon nanotubes have diameters which are of about 10,000 times smaller than that of human hair. The mean length of the carbon nanotubes is between from about 0.1 μm to about 10 μm, and the mean length/mean diameter aspect ratio is from about 1 to about 28,000,000 μm. The characteristics of carbon nanotubes may be determined by the method employed in their synthesis. Due to their very small (colloidal) size, the carbon nanotubes have large surface areas. They further are characterized by very low apparent density (not compacted): typically between from about 0.03 g/cm³ to about 0.5 g/cm³.

The unique molecular structure of the carbon nanotubes provides them exceptional mechanical, thermal, electrical and optical properties.

The carbon nanotubes are characterized by high specific strength, for instance up to 48,000 kNm/kg compared to 154 kNm/kg of high-carbon steel. They also exhibit very good thermal conductivity along the tube (calculated ballistic conduction to be 2,000 W/mK).

The electric conductivity of carbon nanotubes depends on their structure (metallic or semiconducting) and increases with temperature, in accordance with power laws of conductance as a function of temperature. It was estimated that metallic nanotubes can have an electrical current density 1,000 times greater than copper or silver.

The carbon nanotubes naturally organize themselves into bundles (agglomerates). For many applications, high performances can be achieved if the carbon nanotubes are de-agglomerated and dispersed into the material (matrix).

Dispersing carbon nanotubes into a matrix (aqueous or organic medium) is a serious challenge. The tubes tend to aggregate, form agglomerates and separate from the dispersion due to the Van der Waals attractions between them. De-agglomerated carbon nanotubes form networks that are responsible for enhanced properties of the material, e.g. strength, thermal conductivity, electrical conductivity, etc.

In order to improve the dispersion of carbon nanotubes into a matrix, it is possible to play on modifications of the physical interactions between them or chemical modifications of their surface. The de-agglomeration and dispersion of carbon nanotubes into various matrices can be achieved with various type of mills, rollers, ultrasound processors (sonicators), high shear-fix geometry processors (e.g. microfluidizer technology) or by functionalization of the nanotubes' surfaces (chemical modification at the nanotubes' surface). The method chosen to de-agglomerate and disperse carbon nanotubes into a matrix may be dependent on the properties of the nanotubes that are to be transferred to the matrix and the process scale. Generally chemically unmodified carbon nanotubes are used to prepare electrically conductive materials. The carbon nanotubes may be chemically or physically purified prior to being dispersed into a matrix, herein into oil.

Because of their high aspect ratio and low percolation threshold, the carbon nanotubes impart electrical conductivity to various matrices at very low levels of concentration. In the electrically conductive oil base muds prepared herein the concentration of carbon nanotubes is typically between from about 0.01% to about 5% by weight, most typically between from about 0.1% to about 2% by weight.

Suitable carbon nanotubes are those disclosed in the literature and may be prepared by electric discharge, laser ablation as well as chemical vapor deposition as well as other techniques known in the art. See for instance, WO 83/03455, WO 03/002456, WO 2007/083725, WO 2009/030868, and WO 2005/113434, herein incorporated by reference. Suitable carbon nanotubes are those commercially available from Bayer Materials Science Germany, Arkema France, Thomas Swan & Co UK, Nanocyl S. A. Belgium, Raymor Industries Inc. Canada, etc. Suitable materials are non-chemically modified carbon nanotubes having a mean diameter of between 1 nm and 16 nm, a mean length of between 0.1 μm and 10 μm and specific surface area greater than 250 m²/g.

The electrically conductive oil base muds defined herein may further contain surfactants. For instance, surfactants may be used to create stable emulsions of water in the continuous organic phase (oil) in drilling fluids with an invert-emulsion base, as known in the art. Additionally surfactants such as ethoxylates, alkoxylates, succinates, pyrrolidones derivatives homo- and co-polymers may be used to disperse the carbon nanotubes in the organic phase of drilling fluids. The hydrophilic-lipophilic balance (HLB) of the non-ionic surfactants may vary, though generally it is greater than 7.

Dispersions of carbon nanotubes in alkyl type organic phase which do not contain surfactants and have good stability over time have been prepared by microfluidization.

When present, the weight ratio of surfactant to carbon nanotubes is between from about 10 to 1 to about 1 to 1, preferably between 5 to 1 and 1 to 1.

The achievable electrical conductivity of the dispersions of carbon nanotubes as well as the achievable electrical conductivity of the oil base drilling fluids is related to the type of oil, the type of carbon nanotubes and their concentration as well as the technology employed to synthesize and purify the carbon nanotubes, the selection of surfactants, the technology chosen to disperse the carbon nanotubes and the processing parameters. For instance, 5 wt % dispersion of carbon nanotubes in an aliphatic oil base has an electrical conductivity of only 23 mScm⁻¹ while 1 wt % dispersion of the same type of carbon nanotubes, in the same aliphatic oil base, prepared with the same technology and the same processing parameters and using the same surfactant, has an electrical conductivity of 48 mScm⁻¹.

Where the drilling fluid contains an emulsion of an aqueous phase in oil, the aqueous phase of the liquid base may further contain one or more water soluble salts, such as sodium salts, potassium salts, calcium salts, ammonium salts, cesium halides and formates and their combinations or polyglycerine.

Further the electrically conductive oil base muds described herein may contain such additives as thinners, filtration control agents, viscosifiers other than the carbon nanotubes, weighting materials etc. known in the art. For instance, suitable viscosifiers for oil base muds may be organophilic clays, normally amine treated clays, oil soluble polymers, polyamide resins, polycarboxylic acids and soaps. When present, such additives may comprise between from about 0.1 wt % to about 6 wt % of the dispersion. The amount of viscosifier used in a composition can vary upon the end use of the composition.

By preparing dispersions in accordance with the methods recited herein, electrically conductive oil base fluids may be obtained containing de-agglomerated carbon nanotubes and stable dispersions of the carbon nanotubes in the continuous organic phase of the fluid base,

The electrical percolation threshold in the fluids with carbon nanotubes described herein depends not only on the type of carbon nanotubes, but also on the organic phase (oil) in which they are dispersed, the dispersability of the nanotubes and the processing. The chemical modification of nanotube surface (the functionalization of carbon nanotubes) that can be used to improve their dispersability in certain matrices is generally not desirable. Usually, the functional groups attached to the surface of the carbon nanotubes modify the distribution of the electrons in the tubes and lead to a decrease of the electrical and thermal conductivities. A decrease of the mechanical strength of the carbon nanotubes by functionalization has been reported as well. Industrially, the de-agglomeration and dispersion of carbon nanotubes by functionalization is also undesirable because of the low concentration of the tubes usually required and the high VOCs evolved.

The dispersions of the carbon nanotubes in organic phases (oils) described herein are preferably prepared with ultrasonic processors (e.g. sonicators) or high shear-fix geometry processors (e.g. microfluidizers). For those dispersions containing surfactant, it is preferred that the carbon nanotubes are added to the solution of surfactant/s in oil. Such solutions are typically obtained by stirring the surfactant and oil at room temperature.

In sonication, the energy of an acoustic field (sound or ultrasound) is applied to the fluid in order to agitate the particles. During sonication, the sonic waves traveling through the liquid lead to the formation, growth, and implosive collapse of bubbles in the liquid (referred to as cavitation). Cavitation agitates the particles in the fluid system. In liquids containing solids or powder suspensions, cavitation occurs near an extended solid surface. Cavity collapse is nonspherical and drives high-speed jets of liquid to the surface. These jets and associated shock waves can damage the surface that is highly heated. The collisions speed dissolution, by breaking intermolecular interactions. The instruments employing this technique have either an ultrasonic bath or an ultrasonic probe. The ultrasonic probe is usually employed in the preparation of the dispersions of nanoparticles.

Dispersions of carbon nanotubes in oils described herein, with concentration of nanotubes between from about 0.001% to about 3.0% by weight have been prepared by sonication.

A suitable sonicator processor for the preparation at laboratory scale of the dispersions of carbon nanotubes in oil or in oil base fluids is Misonix Sonicator 4000 from Misonix Inc. The sonicator may be equipped with various ultrasonic probes taking into account the type of material and the volume processed. A suitable sonicator processor for large volume processing (industrial scale) is the UIP16000 Processor from Hielschler Ultrasonics GmbH. In order to achieve the desirable electrical conductivity optimum processing parameters have to be experimentally established for each formulation.

The dispersions of carbon nanotubes in oil described herein may also be prepared by microfluidization, typically under high pressure and high shear. For instance, microfluidization may use the microfluidizer processors pioneered by Microfluidics International Corporation. The heart of the interaction chamber in microfluidization consists of “fixed geometry” microchannels. The small channel diameters decrease the Reynolds number so fluids may be mixed through diffusion. Flow through the chamber is characterized by high fluid velocities (up to 500 m/s) and subsequent impingement of fluid jets to the chamber walls or to one another.

Microfluidization produces shear several orders of magnitude higher than that of conventional mixing equipment, with constant pressure (as opposed to constant volume) leading to very small particle size and narrow particle size distribution. The efficient elimination of heat allows the use of this technology for mixing heat-sensitive materials as well.

Microfluidization combines mechanism of cavitation, shear, and impact, exhibiting excellent dispersion/emulsification efficiency and leads to dispersions/emulsions with high stability. In some instances, the stability over time of dispersions (e.g. shelf life) may be more improved when using microfluidizers versus sonicators.

Dispersions of carbon nanotubes in oils described herein, with concentration of nanotubes between from about 0.001% to about 5.0% by weight have been prepared by microfluidization.

Suitable microfluidizers for preparation of dispersions at laboratory scale is the M-110P Microfluidizer Processor. For large volume of dispersions (industrial scale) processors such as M-7125-10, M7250-10 or M710-10 may be used.

The electrical conductivity of dispersions discussed herein increases as the concentration of nanotubes increases. For instance, a dispersion of multi-walled carbon nanotubes having an average outer diameter between 10 nm and 15 nm and length between 10 μm and 15 μm in a hydrocarbon type oil, after 1 pass through a M-110P Microfluidizer Processor equipped with a H30Z interaction chamber exhibited an electrical conductivity of 10 mScm⁻¹ with 0.5 wt % nanotubes, 32 mScm⁻¹ with 1.0 wt % and 102 mScm⁻¹ with 2.0 wt % carbon nanotubes.

The electrical conductivity of dispersions and fluids is strongly dependent on the volume fraction of the conductive phase. At very low volume fractions, the conductivity remains very close to the conductivity of the pure organic phase. When a certain volume fraction is reached, the conductivity drastically increases by many orders of magnitude. The phenomenon is known as percolation and can be well explained by percolation theory. At room temperature the electrical conductivity of hydrocarbon type oils used is in the 10⁻¹² Sm⁻¹ range and becomes 10⁻¹⁰ to 10⁻⁸ Sm⁻¹ after the addition of surfactants (non-ionic or ionic). As per previous example 0.5% by weight carbon nanotubes added to the mixture of solvent and surfactant leads to an increase of electrical conductivity by 8 to 10. Orders of magnitude while an addition of 2% by weight carbon nanotubes leads to an increase of electrical conductivity by about 12 to 14 orders of magnitude.

Further, the viscosity of the dispersions of carbon nanotubes in oil as well as the viscosity of oil base drilling fluids also increases with increasing concentration of the carbon nanotubes (all other factors remaining the same).

Higher viscosities have been evidenced when non-ionic and polymeric surfactants in hydrocarbon solvents have been used in comparison to the use of ionic surfactants only. The influence of the surfactant used to disperse carbon nanotubes has been better seen in electrically conductive drilling fluids in which the carbon nanotubes also played the role of the only viscosifier. These fluids were used as well to better evaluate the thixotropic properties of the carbon nanotubes. Further these fluids allowed assessing the influence of the concentration of carbon nanotubes and the type of surfactant used to disperse them on the thixotropic properties of the electricaly conductive drilling fluids.

Unweighted and weighted electrically conductive oil base muds may have a density between from about 0.7 to about 2.2 g/cm³. Suitable weighting materials for use in the oil base drilling fluids defined herein are those known in the art: the barite (BaSO₄), calcite (CaCO₃), dolomite (CaCO₃.MgCO₃), hematite (Fe₂O₃), magnetite (Fe₃O₄), ilmenite (FeTiO₃), and siderite (FeCO₃). The weighting material used is barite.

Further the rheological behaviour of the electrical conductive oil base drilling fluids with carbon nanotubes has been assessed as well. The mathematical model that better describes the rheological behaviour of drilling fluids described herein is the Herschel-Bulkley Model.

The electrical conductivity of the oil base muds described herein has been assessed with commercial available instruments such as the Rosemount Analytical Conductivity Meter Model 1056, equipped with the 226 Toroidal Conductivity Sensor (inductive conductivity sensor) and the RM 744 Fluid Resistivity Meter supplied by Intertek UK (the electrical resistivity is the inverse of the electrical conductivity). The electrical conductivity of drilling fluids described herein generally increases with increasing concentration of carbon nanotubes. For concentrations of carbon nanotubes of less than 1% by weight to the organic phase of the fluid base electrical resistivity values of less than 10 μm preferably less than 5 Ωm have been recorded. In view of the low electrical resistivity (high electrical conductivity) of the oil base drilling fluids described herein, they are suitable for use in well logging with conventional resistivity imaging devices unlike the conventional oil base drilling fluids which are electrically non-conductive.

Further the oil base drilling fluids with carbon nanotubes exhibit very good thermal stability.

For the oil base drilling fluids described herein which have an invert emulsion base the stability of the emulsion in the presence of carbon nanotubes has been assessed by Dynamic Light Scattering. Further no separation of the water has been observed during the preparation or testing of these fluids. The oil base drilling fluids with carbon nanotubes disclosed herein are stable over time.

The following examples are illustrative of some of the embodiments of the present invention. Other embodiments within the scope of the claims herein will be apparent to one skilled in the art from consideration of the description set forth herein. It is intended that the specification, together with the examples, be considered exemplary only, with the scope and spirit of the invention being indicated by the claims which follow.

All percentages set forth in the Examples are given in terms of weight units except as may otherwise be indicated.

### EXAMPLES

Measurements of electrical conductivity were performed at various temperatures, in order to determine a) the conductivity of the oils used to prepare the dispersions of carbon nanotubes, b) the conductivity of the solutions of surfactants in oils, c) the evolution of the electrical conductivity with the content of carbon nanotubes of dispersions and drilling fluids, and d) the evolution of the electrical conductivity with temperature.

Because the electrical conductivity of the pristine oils is very low comparatively with the conductivity of dispersions of carbon nanotubes in oils and the conductivity of drilling fluids with carbon nanotubes, different electrical conductivity meters were used.

The electrical conductivity of oils and of the solutions of surfactants in oils were assessed with a conductivity meter Model DT-700 with non-aqueous conductivity probe supplied by Dispersion Technology Inc. (NY, USA). The meter allowed measuring electrical conductivity in the 10⁻¹⁴ to 10⁻⁴ Sm⁻¹ range.

The electrical conductivity of the dispersions of carbon nanotubes in oils and of drilling fluids with carbon nanotubes was measured with a Rosemount Analytical Conductivity Meter Model 1056, equipped with the 226 Toroidal Conductivity Sensor (inductive conductivity sensor). The electrical conductivity of dispersions and drilling fluids was also assessed with a Fluid Electrical Resistivity Meter, the RM 744, from Intertek UK.

### Example 1

The surfactants (an alkyl pyrrolidone, commercially available as SURFADONE® LP-300 from ISP), and a succinate, commercially available as TRITON® GR-7M from The Dow Chemical Company, were added to the oils (an ester oil commercially available as BDMF VLV, a product of Oleon; a C₁₅-C₁₈ paraffin oil; a hydrocarbon oil containing 30% aromatic compounds; and a hydrocarbon oil containing C₁₁-C₁₆ aliphatics) and stirred for 30 minutes at room temperature. The electrical conductivity of the pristine oils and the solutions of surfactants in oils were measured at room temperature, 150 F (65.5° C.) and 250 F (121.1° C.). During the measurements, the temperature of the samples was kept constant by use of a thermostat ISOTEMP 210.

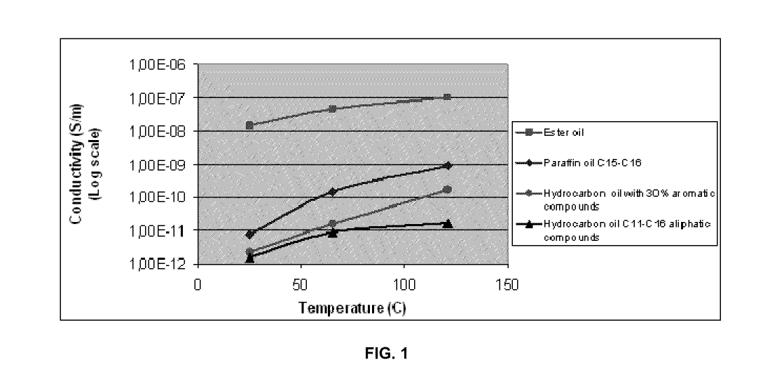

The electrical conductivity of oils used to formulate drilling fluids is very low, at both room temperature and high temperatures. As an example, FIG. 1 shows the evolution with temperature of the electrical conductivity of four oils. At room temperature the electrical conductivity of the hydrocarbon oils was in the 10⁻¹² Sm⁻¹ range and the electrical conductivity of the ester oils was in the 10⁻⁸ Sm⁻¹ range. The conductivity of oils increases with the temperature increase, at 250 F (121.1° C.) the electrical conductivity of the hydrocarbon type oils is in the 10⁻¹⁰ to 10⁻¹¹ Sm⁻¹ range and those of ester type oils in the 10⁻⁷ Sm⁻¹ range.

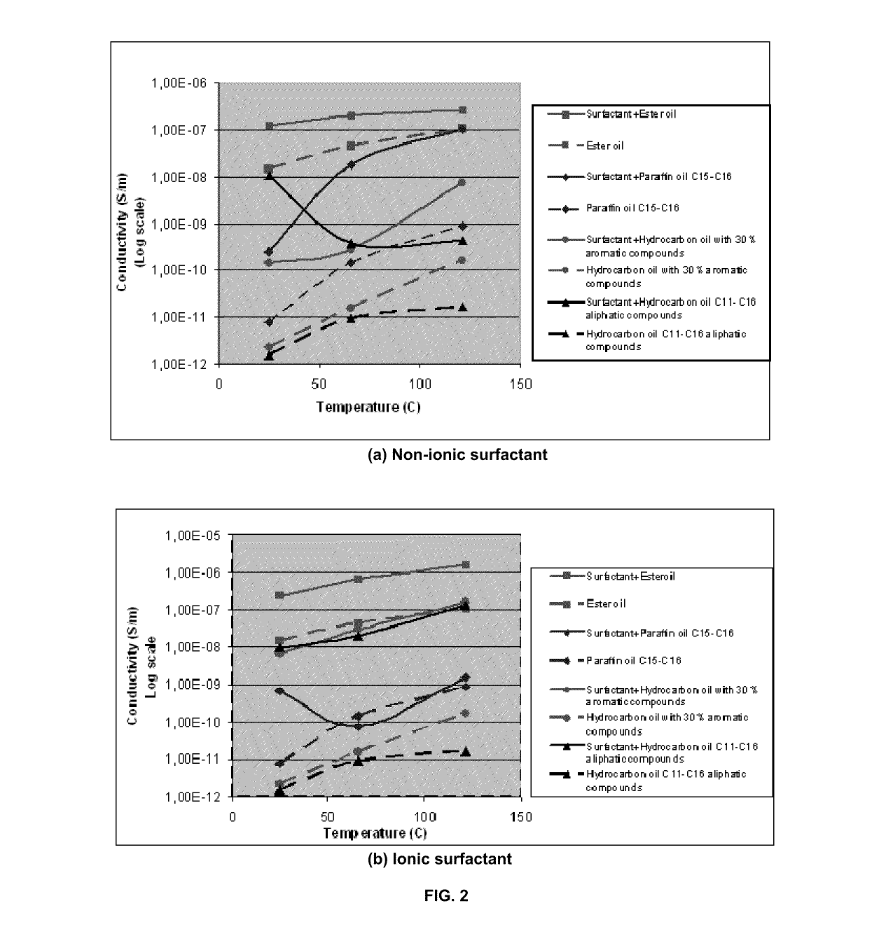

At room temperature, the addition of surfactants (2 wt %) to oils led to an increase of the electrical conductivity values by one to four orders of magnitude, as illustrated in FIG. 2. For the same concentration of surfactant, an increase of less than two orders of magnitude was witnessed for the addition of an alkyl pyrrolidone surfactant to oils that are mixtures of aliphatic and aromatic hydrocarbons. Conversely for the addition of this surfactant to oils that are mixtures of aliphatic hydrocarbons only an increase of four orders of magnitude was observed. The addition of the succinate surfactant to all the hydrocarbon type oils led to an increase in electrical conductivity by more than three orders of magnitude. Except for the ester type oil an increase by one to two orders of magnitude with the temperature increase has been witnessed for the pristine oils and the solutions of surfactants in oils.

### Example 2

Electrically conductive dispersions of industrial grades carbon nanotubes in organic phases (oils) of oil base drilling fluids were prepared by sonication and microfluidization. Carbon nanotubes from various suppliers were dispersed in various oils, optionally in the presence of commercially available surfactants (ionic, non-ionic, or polymeric). Prior to processing, the nanotubes were “oil pre-wetted”. The carbon nanotubes were added to the solutions of surfactant(s) in oil and stirred with a magnetic stirrer or a mechanical stirrer for 10 to 30 minutes or to oils and sonicated for 30 to 60 seconds. The dispersions contained 0.2 wt % of carbon nanotubes.

For the preparation of dispersions, a Misonix Sonicator 4000 equipped with a standard ultrasonic probe (ø=12.7 mm) was used. Alternatively a Microfluidizer Processor, model M-110P equipped with either a H10Z (100 μm) interaction chamber or H30Z (200 μm) interaction chamber was employed. When the sonicator has been used, the dispersions have been sonicated several times, with amplitudes of 10 to 30 μm for 10 to 30 minutes. With the microfluidizer, various pressures between 2.0 kpsi to 30.00 kpsi were used to prepare dispersions of carbon nanotubes supplied by various manufactures. At the same pressure, each dispersion was processed several times (several numbers of passes through the microfluidizer).

After each sonication or pass through the microfluidizer pictures of the dispersions were taken with an optical microscope (Optiphot 100 microscope from Nikon coupled with a Clemex Image Analyzer system) and the electrical conductivity/resistivity was measured. Additional information about the dispersions was collected by Scanning Electron Microscopy (SEM). A JSM840A, JEOL Scanning Electron Microscope equipped with a LINK Energy Dispersive Spectrometry (EDS) system from Oxford was used. When present, the weight ratio surfactant to carbon nanotubes was 5:1.

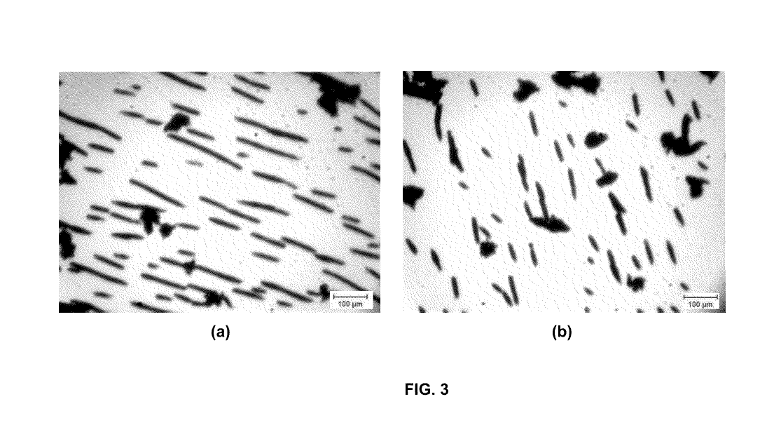

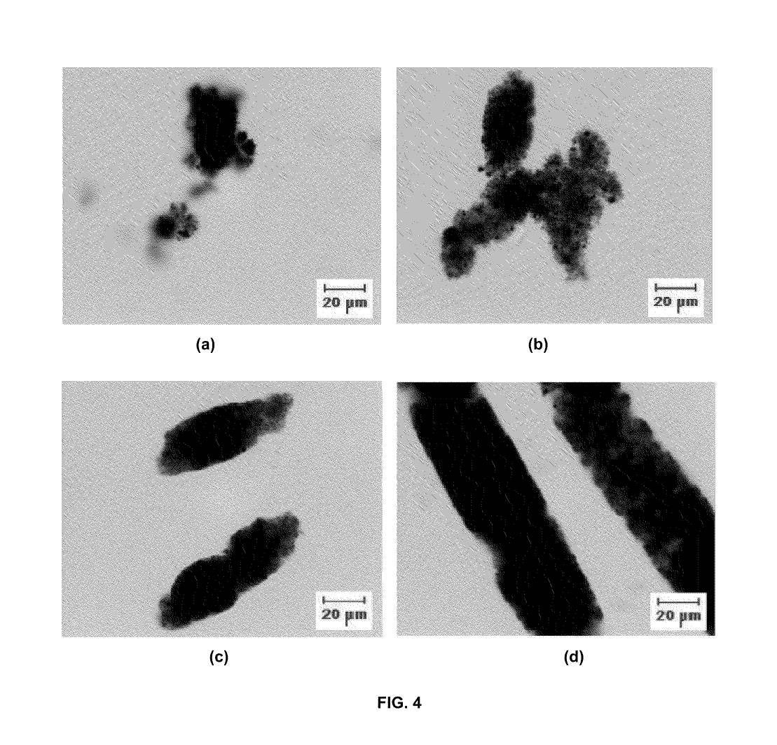

For the same type of tubes and same solvent, different morphologies were observed in the early stages of processing, for dispersions prepared with the three types of surfactants mentioned above. The morphology of dispersions prepared with the non-ionic and polymeric surfactants was controlled by the presence of single or grouped rods with various lengths (˜20 to 200 μm), for both sonication and microfluidization processing. Only a few aggregates with irregular shapes and various sizes was observed in the micrographs, and they were mainly formed in the dispersions prepared by sonication. As an example, FIG. 3 showed two dispersions of 0.2 wt. % carbon nanotubes (available as Baytubes C 150 HP from Bayer Materials Science) in a synthetic solvent (a mixture of C₁₁-C₁₆ aliphatic hydrocarbons) in the presence of (a) the alkyl pyrrolidone surfactant and (b) nonylphenol ethoxylate surfactant (NP-4), weight ratio surfactant to carbon nanotubes being 5:1. The dispersion was prepared by sonication with an amplitude of 15 μm, for 30 minutes. The rods and the irregular aggregates were formed by smaller aggregates of tubes, whose dimensions were also within the micrometer range (˜5 to 10 μm). An increase in the dimensions of rods with the increase of the processing pressure was recorded for the dispersions prepared by microfluidization. FIG. 4 showed unprocessed aggregates of carbon nanotubes and rod like aggregates formed in the first pass through the microfluidizer at 3.5 kpsi, 8.0 kpsi and 15.0 kpsi constant pressures. In FIG. 4, the dispersions contained 0.2 wt. % MWNT (commercially available as Graphistrength C 100 from Arkema) in hydrocarbon solvent with 30% by volume aromatic hydrocarbons, in the presence of the alkyl pyrrolidone surfactant; weight ratio 5 to 1 surfactant to carbon nanotubes. FIG. 4 (a) is the unprocessed sample after 30 seconds in a sonicator bath; FIGS. 4 (b-d) show dispersions run at various processing pressures after 1 pass through the M-110 P Microfluidizer processor with H10Z (100 μm) interaction chamber.

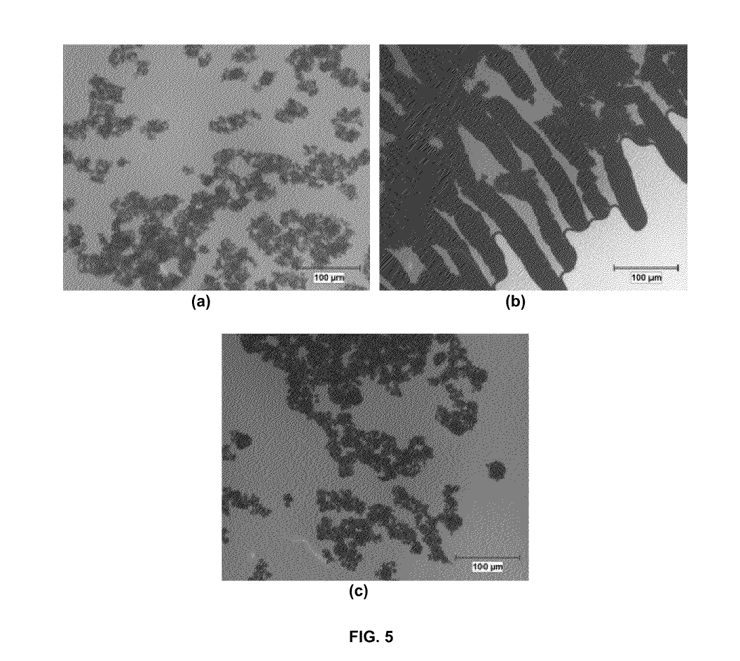

The morphology of the dispersions prepared with the ionic surfactant, by both sonication and microfluidizer technology, is ruled by aggregates with irregular shapes and is very similar to the morphology of dispersions prepared without surfactant. FIG. 5 shows the optical micrographs of dispersions of MWNTs in a hydrocarbon solvent with 30% by volume aromatic hydrocarbons, prepared by microfluidization, without surfactant and with two different surfactants. In particular, FIG. 5 shows dispersions of 1.0 wt. % carbon nanotubes (commercially available as NC-7000 from Belgium Nanocyl) in hydrocarbon oil with 30% by volume aromatic hydrocarbons, prepared with the M-110 P Microfluidizer Processor equipped with a H10Z (100 μm) interaction chamber wherein FIG. 5 (a) illustrates a dispersion with no surfactant; 4 passes at 15.0 kpsi; (b) illustrates a dispersion containing alkyl pyrrolidone surfactant, weight ratio 5 to 1 surfactant to carbon nanotubes; 3 passes at 8.0 kpsi; and (c) illustrates a dispersion containing the succinate surfactant, weight ratio 5 to 1 surfactant to carbon nanotubes; 4 passes at 15.0 kpsi. The morphology of dispersions changes with the extent of processing (processing level) and 3D networks of aggregates were formed.

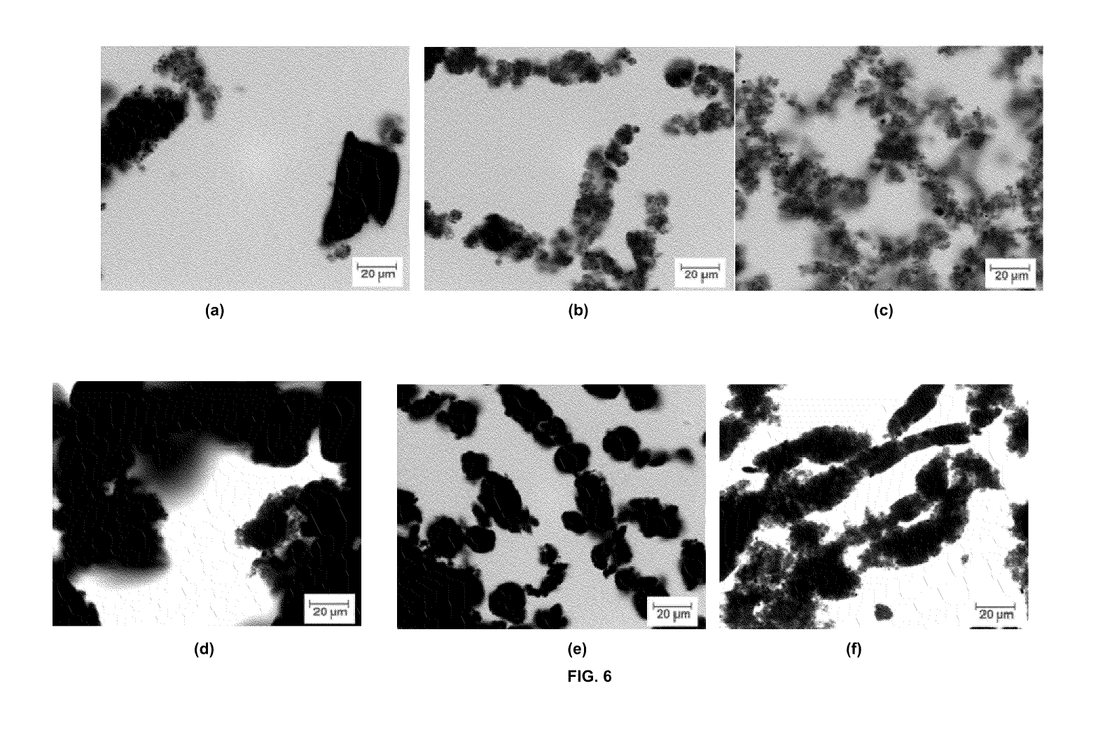

FIG. 6 shows the evolution of the morphology of dispersions prepared with M-110 P Microfluidizer processor equipped with a H10Z (100 μm) interaction chamber in a solvent with 30% by volume aromatic hydrocarbons. In FIG. 6 (a) to (c), the dispersion contained 0.2 wt % Bayer carbon nanotubes (Baytubes C 150 HP) in hydrocarbon solvent; succinate surfactant; weight ratio 5 to 1 surfactant to carbon nanotubes wherein (a) was unprocessed, (b) was processed at 1 pass at 15.0 kpsi and (c) was processed at 2 passes at 15.0 kpsi. In FIG. 6 (d) to (f), the dispersion contained 1 wt % MWNT Graphistrength C 100 in hydrocarbon type solvent; nonylphenol ethoxylate surfactant; weight ratio of surfactant:carbon nanotubes was 5:1 wherein (d) was unprocessed, (e) was processed at 1 pass at 8.0 kpsi and (f) was processed at 2 passes at 8.0 kpsi. The size of the aggregates decreased dramatically if the dispersions were over processed.

The evolution of the morphology investigated by optical microscopy explained the evolution during processing of the electrical conductivity of dispersions. The electrical conductivity of dispersions of carbon nanotubes increased during processing up to certain level and decreased if processing was too long. Optimum processing conditions had to be established for each system and each type of processing, in order to maximize the electrical conductivity of the dispersions of carbon nanotubes.

The investigation of the morphology of dispersions by SEM, showed that the aggregates that had been seen in the optical micrographs of the dispersions are mainly formed by entangled carbon nanotubes. Traces of catalysts used to synthesize the nanotubes were detected as well by SEM. No individual tubes were revealed by the SEM micrographs of the dispersions of carbon nanotubes studied.

The stability over time of dispersions with carbon nanotubes was assessed as well. As an example the electrical resistivity of a fresh 2% by weight dispersion of carbon nanotubes with an outer diameter of 9.5 nm, a length of 1.5 μm and a surface area between 250 and 300 gcm⁻² was 0.085 Ωm and after 3 months it was 0.090 Ωm.

### Example 3

Unweighted and weighted electrically conductive oil base drilling fluids with carbon nanotubes with various compositions were prepared. The fluids contained additives as thinners, filtration control agents, viscosifiers, other than the carbon nanotubes, rheological modifiers, weighting materials etc. The fluids may have a continuous base that is an invert emulsion or oil. The selected components and the carbon nanotubes were added to a chosen oil base in a particular sequence. The electrical conductivity/resistivity of the fluids was measured after preparation, aging and over certain periods of time. The reological behaviour of the drilling fluids, their thixotropic properties and filtration control properties at high pressure high temperature (HPHT filtration control) were assessed according to the standardized methods for oil base drilling fluids. The fluids described were prepared by either the addition of an electrically conductive dispersion of carbon nanotubes in oil to a conventional oil base mud or the sonication of a mixture of oil pre-wetted carbon nanotubes and an unweighted conventional oil base drilling fluid.

3(a). This example was directed to a drilling fluid having a density of 1.52 g/cm³ and containing a hydrocarbon oil base. The content of the carbon nanotubes (NC-7000) in the fluid was 0.5% by weight carbon nanotubes to the oil. The carbon nanotubes were dispersed in the oil phase of the liquid in the presence of TRITON GR-7M. Barium sulfate was used as weighting material. Among other components the oil contained a relatively low amount of organophilic clay. The physical properties of the fluid were characterized as follows:

Electrical resistivity*: 12.4 Ωm

### Rheology:

600 rpm: 90.0

300 rpm: 59.0

200 rpm: 47.0

100 rpm: 33.0

6 rpm: 11.0

3 rpm: 9.0

### Gel:

10 seconds: 10

10 minutes: 11

30 minutes: 12

HPHT Filtration control**:

Volume of filtrate (ml): 10

Cake thickness ( 1/32″): 2.5 * Measured with a RM-744+ Fluid Resistivity Meter equipped with two testing cells, a regular cell, for resistivity values between 0-19.999 Ωm, and a prototype cell for resistivities between 20-200 Ωm.** Assessed according to the specifications for oil base drilling fluids (HPHT filtration test) at 250° F. (121.1° C.) and 500 psi (3500 kPa) differential pressure.

3(b) Drilling fluids with an invert emulsion base containing 20% by volume water, 28 wt % calcium chloride and having a density of 1.68 gcm⁻³ were prepared. The content of the carbon nanotubes (NC-7000) in the fluid was 1% by weight to the continuous oil phase. The fluid also contained an alkyl pyrrolidone surfactant and dimer (of C₁₈) acid. No filtration additive and no organophilic clay were used to formulate the fluid. The physical properties of the fluid were characterized as follows:

Electrical resistivity*: 3.32 Ωm

### Rheology:

600 rpm: 90.0

300 rpm: 54.0

200 rpm: 44.0

100 rpm: 28.0

6 rpm: 8.0

3 rpm: 6.0

### Gel:

10 seconds: 7

10 minutes: 7

30 minutes: 7

HPHT Filtration control**:

Volume of filtrate (ml): 35.0 (the carbon nanotubes did not provide filtration control)

Cake thickness ( 1/32″): --

3(c). A drilling fluid with an invert emulsion base containing 10% by volume water; 32 wt % calcium chloride and having a density of 1.37 g/cm³ was prepared. The content of the carbon nanotubes (NC-7000) in the fluid was a 0.5% by weight to the continuous oil phase. The oil was a mixture of hydrocarbons containing 30% by volume aromatic hydrocarbons. A mixture of ionic and non-ionic surfactants [N-octyl-2-pyrrolidone and 1,4-bis-(2-ethylhexyl) sodium sulfosuccinate] was used to ensure a good dispersability of the carbon nanotubes into the oil. The fluid did not contain organophilic clay. Among other components the fluid contained a polymeric filtration control additive, commercially available as DF-O1, a product of Elikem. The physical properties of the fluid were characterized as follows:

Electrical resistivity*: 3.37 Ωm

### Rheology:

600 rpm: 64.0

300 rpm: 41.0

200 rpm: 31.5

100 rpm: 22.0

6 rpm: 8.0

3 rpm: 6.5

### Gel:

10 seconds: 6.5

10 minutes: 7

30 minutes: 8

HPHT Filtration control**:

Volume of filtrate (ml): 19.5

Cake thickness ( 1/32″): 2

3(d) Unlike the previous examples in which the drilling fluids were prepared by the addition of the dispersion of carbn nanotubes in oil to the weighted mud, the fluid in this example was prepared by the sonication of the mixture of oil (D888) pre-wetted carbon nanotubes (NC-7000) and an unweighted conventional oil base mud. The fluid had an invert emulsion base containing 10% by volume water; 32 wt % calcium chloride and had a density of 1.37 gcm⁻³. The content of the carbon nanotubes in the fluid was 0.5% by weight to the continuous oil phase. The fluid contained 1,4-bis-(2-etylhexyl) sodium sulfosuccinate as surfactant (weight ratio of surfactant to nanotubes being 5:1) and 5 kg/lm³ drilling fluid of Cybertrol™ filtration control additive. The fluid was free of clay. The physical properties of the fluid were characterized as follows:

Electrical resistivity*: 3.21 Ωm

### Rheology:

600 rpm: 50.0

300 rpm: 31.0

200 rpm: 24.5

100 rpm: 17.0

6 rpm: 6.0

3 rpm: 5.0

### Gel:

10 seconds: 4.5

10 minutes: 5.0

30 minutes: 8.5

HPHT Filtration control**:

Volume of filtrate (ml): 23

Cake thickness ( 1/32″): 2

The electrical conductivity/resistivity of a drilling fluid may be modified by varying the concentration of carbon nanotubes in the fluid. As illustrated in the above examples, resistivity values lower than 5 ohm-m, corresponding to electrical conductivity values higher than 0.2 Sm⁻¹ (2000 μScm⁻¹), were obtained.

The foregoing disclosure and description of the invention is illustrative and explanatory thereof, and various changes and modifications may be made without departing from the spirit of the invention.

What is claimed is:

1. An electrically conductive oil base drilling fluid comprising carbon nanotubes in an oil dispersion.

2. The electrically conductive oil base drilling fluid of claim 1, wherein the oil dispersion is a continuous organic phase containing the carbon nanotubes.

3. The electrically conductive oil base drilling fluid of claim 2, wherein the oil of the oil dispersion is selected from the group consisting of mineral oils, paraffin oils, diesel oils, and synthetic oils.

4. The electrically conductive oil base drilling fluid of claim 1, wherein the carbon nanotubes are in an invert emulsion of water in oil.

5. The electrically conductive oil base drilling fluid of claim 4, wherein the oil of the oil dispersion is selected from the group consisting of mineral oils, paraffin oils, diesel oils, fluorinated oils and synthetic oils.

6. The electrically conductive oil base drilling fluid of claim 4, wherein the content of water of the invert emulsion base is of most 40% by volume.

7. The electrically conductive oil base drilling fluid of claim 1, wherein the amount of carbon nanotubes in the drilling fluid is between from about 0.01% to about 5% by weight.

8. The electrically conductive oil base drilling fluid of claim 7, wherein the amount of carbon nanotubes in the drilling fluid is between from about 0.1% to about 2% by weight.

9. The electrically conductive oil base drilling fluid of claim 1, wherein the drilling fluid further comprises an ionic, non-ionic or polymeric surfactant.

10. The electrically conductive oil base drilling fluid of claim 9, wherein the amount of surfactant in the drilling fluid is between from about 10:1 to about 1:1.

11. The electrically conductive oil base drilling fluid of claim 10, wherein the amount of surfactant in the drilling fluid is between from about 5:1 to about 1:1.

12. The electrically conductive oil base drilling fluid of claim 1, wherein the oil dispersion is prepared by sonication or microfluidization.

13. The electrically conductive oil base drilling fluid of claim 12, wherein the dispersion is prepared by sonication.

14. The electrically conductive oil base drilling fluid of claim 13, wherein the sonication amplitude is between 10 μm to 30 μm.

15. The electrically conductive oil base drilling fluid of claim 13, wherein the dispersion is sonicated for about 10 to about 30 minutes.

16. The electrically conductive oil base drilling fluid of claim 1, wherein the dispersion is prepared by microfluidization.

17. The electrically conductive oil base drilling fluid of claim 16, wherein the diameter of the microchannels in the microfluidizer are greater than about 50 microns.

18. The electrically conductive oil base drilling fluid of claim 16, wherein the electrical resistivity of the dispersion used to prepare the fluid is less than 0.1 Ωm.

19. The electrically conductive oil base drilling fluid of claim 1, wherein the electrical resistivity of the drilling fluid is less than 20 Ωm.

20. The electrically conductive oil base drilling fluid of claim 19, wherein the electrical resistivity of the drilling fluid is less than 5 Ωm.

21. A method of drilling a borehole which comprises introducing into the borehole and circulating in the borehole the oil base drilling fluid of claim 1.

22. The method of claim 21, wherein the well has a depth of at least 5,000 meters.

23. A method of well logging with resistivity-imaging logging devices which comprises introducing into the borehole and circulating in the borehole the oil base drilling fluid of claim 1.
